(19) United States
(12) Patent Application Publication
(10) Pub. No.: US 2002/0168983 A1
(43) Pub. Date: Nov. 14, 2002

(54) Assigning frequency channels in a cellular system

(76) Inventors: Krishnan Kumaran, Scotch Plains, NJ (US); Boris D. Lubachevsky, Bridgewater, NJ (US)

Correspondence Address: Docket Administrator (Rm. 3J-219), Lucent Technologies Inc., 101 Crawfords Corner Road, Holmdel, NJ, 07733, US

(21) Appl. No.: 09/900,374

(22) Filed: Jul. 6, 2001

Related U.S. Application Data
(60) Provisional application No. 60/290,130, filed on May 10, 2001.

(51) Int. Cl. H04Q 7/20

(52) U.S. Cl. 455/446; 455/423; 455/450

(57) ABSTRACT

A process assigns frequency channels to service communications in a cellular wireless system. The process includes performing a simulation of the system to produce a plurality of lists of channel rankings and assigning the lists of produced channel rankings to the base stations for use in assigning channels to service communications with mobile units. The simulation evolves the lists of channel rankings according to an algorithm that dynamically reduces inter-communication interference. Individual lists of channel rankings prioritize the channels for servicing communications by associated individual base stations.

This application claims the benefit of U.S. Provisional Application No. 60/___,___, titled “Assigning Frequency Channels In A Cellular System”, by Krishnan Kumaran and Boris D. Lubachevsky, filed May 10, 2001.

### BACKGROUND OF THE INVENTION

1. Field of the Invention

This invention relates generally to wireless communications and, more particularly to cellular wireless systems.

2. Discussion of the Related Art

In a cellular system, a coverage region includes a plurality of coverage cells in which different base stations service cellular communications. Each base station has a set of frequency channels to support communications with mobile units located in the one or more cells serviced by the station. Since a cellular system licenses a fixed frequency spectrum, the channels of the spectrum must be shared by different users.

Different ways of sharing frequency channels among the various base stations of the system often provide different call and data capacities. To increase the call and data capacity, the same frequency channel is available to support more than one simultaneous cellular communication. The level of such channel reuse is however, limited by interference that the reuse causes between different communications. Interference occurs among different communications supported by the same frequency channel, e.g., to adjacent base stations, and among different communications supported on adjacent frequency channels. One goal in the design of cellular systems is to increase system capacities by enabling more reuse of frequency channels by base stations while minimizing interference between independent communications.

Some cellular systems implement time division multiple access (TDMA) to support communications between base stations and cellular users. In TDMA, a base station defines a series of time slots in individual available frequency channels. The base station uses the different time slots in a frequency channel to support simultaneous communications with different users.

### BRIEF SUMMARY OF THE INVENTION

Various embodiments prioritize the frequency channels of a cellular system for servicing communications based on learning. In particular embodiments, the learning results from processing communication traffic by a dynamical algorithm that evolves lists of channel rankings associated with base stations in a manner that reduces overall inter-communication interference. The lists prioritize the channels for use in servicing communications by the base stations. The algorithm evolves the channel rankings towards a stable fixed point. The fixed point provides lists of channel rankings that enable the same channels to be used by different ones of the angular sectors without above-threshold interference between independent communications. The fixed-point values of the channel rankings provide for better operation of the cellular system, i.e., high capacity and/or lower interference, than the initial channel ranges and typically, are not strongly dependent on the initial channel rankings.

In one aspect, the invention features a process for assigning channels to service communications in a cellular wireless system. The process includes performing a simulation of the system to produce a plurality of lists of channel rankings and assigning the lists of produced channel rankings to the base stations for use in assigning channels to service communications with mobile units. The simulation evolves the lists of channel rankings according to an algorithm that dynamically reduces inter-communication interference.

In another aspect, the invention features a program storage medium encoded with a computer executable program that is configured to perform the above-described process.

### BRIEF DESCRIPTION OF THE DRAWINGS

FIG. 1 shows an exemplary cellular wireless system;

FIG. 2 shows a list that ranks frequency channels for servicing communications by one angular sector of FIG. 1;

FIG. 3 schematically illustrates a system that determines rankings of frequency channels in the cellular wireless system of FIG. 1;

FIG. 4 is a flow chart for a process that provides lists that rank frequency channels for use by the angular sectors in the cellular system of FIG. 1;

FIG. 5 is a flow chart illustrating a program that simulates the evolution of lists of frequency channel rankings dynamically;

FIG. 6 shows data structures used by the program of FIG. 5 to dynamically evolve lists of frequency channel rankings for the cellular wireless system of FIG. 1;

FIG. 7 is a flow chart that shows how the program of FIG. 5 processes a new communication creation event;

FIG. 8 is a flow chart that shows how the program of FIG. 5 processes a communication dialing or set up event;

FIG. 9 is a flow chart that shows how the program of FIG. 5 processes a communication maintenance event;

FIG. 10 is a flow chart that shows how the program of FIG. 5 processes a communication termination event;

FIG. 11 is a flow chart that shows how the program of FIG. 5 processes an event to re-rank or reprioritize usage of frequency channels;

FIG. 12 is a flow chart that shows how the program of FIG. 5 processes an event to determine the stability for the cellular system's channel ranking lists; and

FIG. 13 is a graphical representation of the evolution of a quantity whose values are indicative of convergence to a fixed point during simulation of a cellular system.

### DETAILED DESCRIPTION OF THE EMBODIMENTS

A dynamical system can incorporate learning into a system's temporal evolution. The various embodiments dynamically evolve a cellular system according to a dynamics to rank channels for use in servicing communications, i.e., calls to and from mobile units, in a manner that produces less interference. The dynamics usually has one or more fixed points that provide lists of channel rankings for use by the actual cellular system.

FIG. 1 shows a portion of a cellular wireless system 2. The cellular wireless system 2 includes mobile units M₁-Mₘ and wireless base stations B₁-Bₙ that are able to communicate with nearby ones of the mobile units M₁-Mₘ. The base stations B₁-Bₙ have fixed locations that are spread over the system's coverage region. Each base station B₁-Bₙ has a set of fixed angular sectors S₁-Sₖ in which the base station is able to maintain independent communications with mobile units M₁-Mₘ. The mobile units M₁-Mₘ are located and may move in the coverage region. At a particular time, one of the mobile units M₁-Mₘ may or may not have active communication set up with one of the base stations B₁-Bₙ.

Each angular sector S₁-Sₖ of a base station B₁-Bₙ describes a range of directions in which the particular base station B₁-Bₙ is able to maintain independent communications. For example, base station B₁ has angular sectors defined by: Θ=0°−120°, Θ=120°−240°, and Θ=240°−360°. In exemplary embodiments, the number, angular size, and orientation of the various angular sectors may differ for different base stations B₁-Bₙ.

Each angular sector S₁-Sₖ has an associated transmission power, reception sensitivity, and a list of channel usage rankings. The power available for communications with a particular mobile unit M₁-Mₘ depends on the sector's transmission power and a fading matrix. Similarly, the sensitivity available for communications with a particular mobile unit M₁-Mₘ depends on the sector's reception sensitivity and the fading matrix. The fading matrix accounts for signal attenuation properties between a particular base station B₁-Bₙ and a particular location, i.e., the location of a mobile unit M₁-Mₘ. The power, sensitivity, and channel ranking may differ for the angular sectors S₁-Sₖ of the same base station B₁-Bₙ.

Different ones of the angular sectors S₁-Sₖ reuse the same set of frequency channels. While reuse of the same or adjacent frequency channel leads to interference between different cellular calls, channel reuse also increases the traffic bandwidth of the cellular system 2. The amount of inter-communication interference depends on proximity's of and transmitted power in angular sectors S₁-Sₖ that use the same and/or adjacent frequency channels during the same time slots.

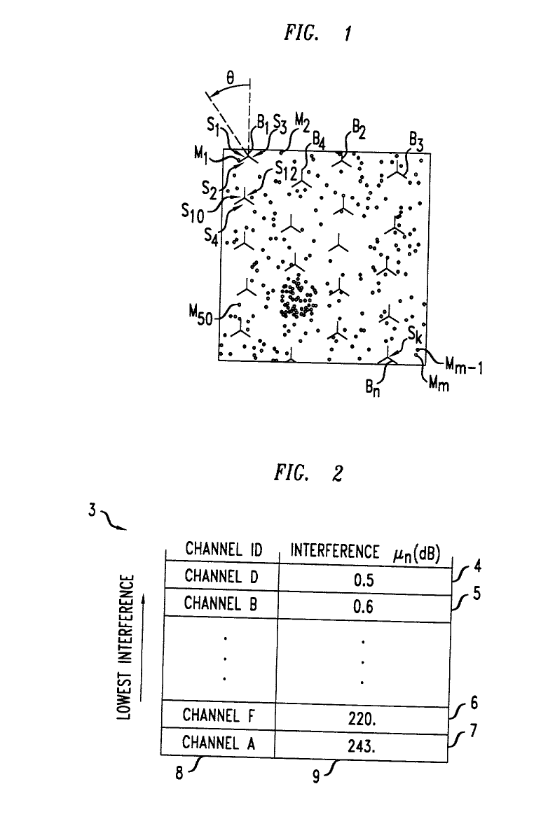

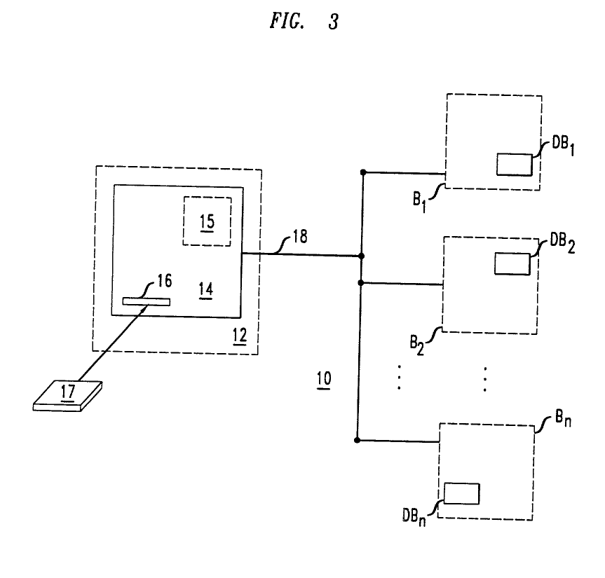

For one angular sector S₁-Sₖ, a channel ranking is a list that prioritizes the frequency channels of cellular system 2 by their quality for supporting communications between the sector and a mobile unit M₁-Mₘ. FIG. 2 shows a list 3 for an exemplary channel ranking of one angular sector. The list 3 has entries 4-7 that provide identifiers 8 and quantities, μₙ, representative of measured interference levels 9 of the frequency channels for communications serviced by the particular angular sector. Typically, the μₙ's are only “representative” of interference levels, because they are defined in a manner that smoothes out rapid fluctuations in interference caused by the usage of frequency channels (see below). The entries 4-7 are ordered so that the channel with the lowest inter-communication interference level, i.e., lowest μₙ, is first and the channel with the highest inter-communication interference, i.e., highest μₙ, is last.

Channel usage by an associated angular sector is controlled by the channel rankings of list 3. The rankings enable the associated base station B₁-Bₙ to find an available channel with lowest interference by searching from the top of the list 3, i.e., the rankings prioritize the channels for use in supporting communications. Such a search can also be used to determine whether the best available channel provides too much interference. Thus, the search determines whether the channel has an above-threshold interference.

For cellular system 2, a complete channel ranking includes “k” instances of lists of channel rankings. Each instance is a list similar in form to the list 3 of FIG. 2. Each list ranks the system's frequency channels for one of angular sectors S₁-Sₖ of therein. In various embodiments, the complete set of lists of channel rankings is dynamically evolved to find a set of lists of rankings that produce low interference for the whole cellular wireless system 2.

FIG. 3 schematically illustrates a system 12 that determines and updates the lists of channel rankings for cellular wireless system 2 of FIG. 1. The system 12 receives input data from base stations B₁-Bₙ and sends new channel assignments to the base stations B₁-Bₙ via link 18. The input data characterizes relevant aspects of the system 12 for determination of the rankings. The system 12 supplies new lists of channel rankings that compensate for changes to system properties such as communication traffic levels and mobile unit distributions. A base station B₁-Bₙ assigns a new communication to the one of its highest ranked channel(s) angular sector S₁-Sₖ that is best oriented to support the communication.

The system 12 includes a microprocessor 14 with an internal data storage device 15, e.g., a hard drive or an active memory, and an external drive 16. The microprocessor 14 executes a computer program that is stored either in internal device 15 or in an external data storage media 17, e.g., an optical or magnetic disk that is executable in drive 16. The program determines a list of channel rankings for each angular sectors S₁-Sₖ of cellular wireless system 2 of FIG. 1. After determining the lists of channel rankings, the processor 14 sends the lists to the base stations B₁-Bₙ via link 18. Each base station B₁-Bₙ stores the lists for the channel rankings for its own angular sectors S₁-Sₖ on an internal data storage device MB₁-MBₙ. To change the channel rankings, e.g., in response to the receipt of new input data from the base stations B₁-Bₙ, the system 12 sends new lists of channel rankings to one or more of the base stations B₁-Bₙ.

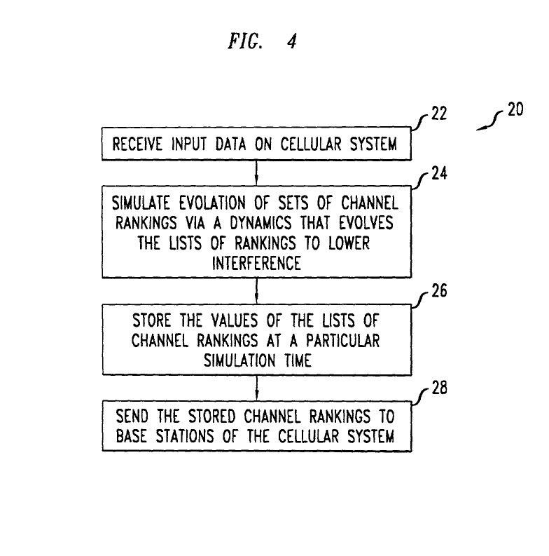

FIG. 4 is a flow chart for process 20 performed by a channel allocation system, e.g., system 12 of FIG. 3, to find lists of channel rankings for use in cellular system 2 of FIG. 1. The allocation system receives input data characterizing the cellular system 2 for which the channel rankings will be made, e.g., data characterizing a city and its suburbs (step 22). The input data includes the cellular system's frequency channel set; the base stations locations; the orientations of angular sectors of the base stations; the local densities and communication traffic rates for mobile units; a fading matrix; and the communication quality requirements. The fading matrix describes signal attenuation values between pairs of base stations and mobile unit locations. The communication quality requirements fix upper bounds on acceptable levels of inter-communication interference.

An exemplary channel ranking process uses uplink communications, downlink communications, or both to determine the lists of channel rankings. For uplink and downlink based systems, the input data also includes reception sensitivities of angular sectors and transmission powers of the various angular sectors, respectively.

The input data may also include reception sensitivities and/or transmission powers of the mobile units.

In some embodiments, additional input data is received by the system that determines the channel rankings. One such type of data characterizes time division multiplexing (TDM) performed by the angular sectors of cellular system 2. For example, TDM data indicates relative time shifts between the start times of multiplexing time slots of the different angular sectors. Another such type of data includes a set of initial lists of channel assignments. For example, this type of data is provided to system 12 of FIG. 3, because the system 12 updates the lists of channel rankings to follow time-dependent changes in the cellular system 2. Another such type of data characterizes durations of communications. Another such type of data characterizes redial rates for block communications. Another such type of data characterizes interference levels or power levels that cause handoff initiations. Another such type of data may describe motion of mobile units M₁-Mₘ through the time evolution of local densities for the mobile units M₁-Mₘ.

In some embodiments, the input data provides for several classes of mobile units that are distinguished by communication quality requirements, motion, redial rates, communication durations, interference tolerances, and/or communication bandwidth requirements.

From the input data, the channel allocation system simulates cellular system 2 of FIG. 1 by a dynamics that evolves the frequency channel rankings to reduce inter-communication interference, i.e., a dynamics that learns how to reduce interference (step 24). The dynamics evolves “k” lists that rank the same set of system frequency channels, e.g., lists like list 3 of FIG. 2, with respect to their usage by the various angular sectors S₁-Sₖ. At any particular simulation time, the channel allocation system stores the lists of channel rankings, which have been produced by the simulated dynamics for each angular sector S₁-Sₖ of the cellular system (step 26).

The simulation evolves channel rankings to reduce overall inter-communication interference while maintaining call blocking and call drop rates below selected threshold values. Thus, the stored lists of channel rankings typically, provide lower interference levels than the initial lists without producing high blocking or drop rates. The channel allocation system sends the stored lists of channel rankings for the angular sectors S₁-Sₖ to the base station B₁-Bₙ on which the sectors S₁-Sₖ are located, e.g., via link 18 in FIG. 3 (step 28).

The received channel rankings, which are lists similar to list 3 of FIG. 2, control subsequent channel usage decisions by base stations B₁-Bₙ. In particular, the base stations B₁-Bₙ assign new communications to or from mobile units M₁-Mₘ to unused communication time-slots of the highest ranked channels based on the rankings of the lists associated with the angular sectors S₁-Sₖ used to support the communications.

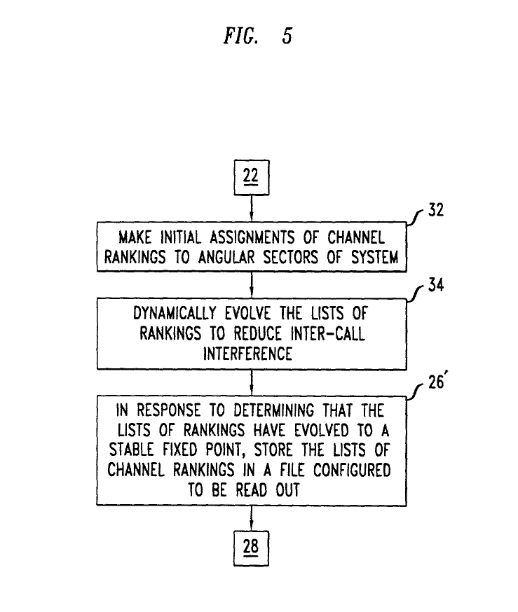

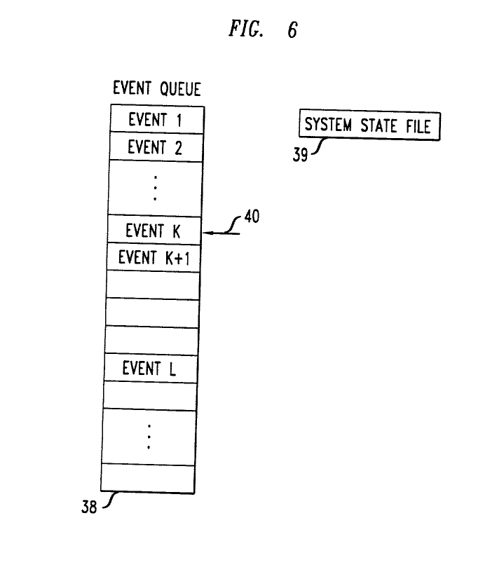

FIG. 5 is a flow chart illustrating one program 30 that implements the simulated dynamics of FIG. 4. First, the program receives a set of initial lists of channel rankings for the angular sectors S₁-Sₖ (step 32). The initial rankings include “k” lists of channel rankings. Each list ranks the same system frequency channels according quantities, μₙ, that are representative of interference that an associated angular sector S₁-Sₖ would encounter in using the channels to support communications. The initial rankings are fixed either randomly or based on input data. For random initial rankings, interference levels are initially assigned in a manner that is consistent with the channel assignments, i.e., higher ranked channels are assigned lower values for the quantities, μₙ, that characterizes inter-communication interference.

After the initial assignments, the program 30 evolves the channel assignments dynamically in a manner that lowers inter-communication interference (step 34). The program processes simulated mobile communications to establish populations of used frequency channels, i.e., channels supporting calls with mobile units, for each angular sector S₁-Sₖ of the system 2 being simulated. The used channels and used time slots thereof for the various angular sectors S₁-Sₖ characterize a time-dependent system state. From the system-state, the program 30 measures interference levels, i.e., values of mₙ, that would occur between communications over various channels for the different angular sectors S₁-Sₖ. Based on the measured interference levels, the program 30 modifies channel rankings, which modifies, in turn, subsequent channel usage by the angular sectors S₁-Sₖ in the simulation. Thus, the program 30 “learns” to reduce interference dynamically while processing simulated communications with mobile units M₁-Mₘ.

The program also regularly makes measurements to determine whether the simulated evolution has neared a stable fixed point from which further evolution of the lists of channel rankings does not occur. In response to being near a fixed point, the program stores the instantaneous lists of channel rankings for the angular sectors S₁-Sₖ to a separate data storage file from which they can be read out (step 26′). The channel allocation system sends these lists of channel rankings to the base stations B₁-Bₙ at step 28 of FIG. 4.

FIG. 6 shows data structures used by one embodiment of program 30 uses to perform an event-driven dynamics. The data structures include an event queue 38 and a system-state file 39. The event queue 38 is a sequence of events that controls the evolution of a discrete-time dynamics simulated by the program. The event queue 38 includes events related to communications, e.g., new call creation, call dialing, call redialing, call maintenance, call termination, call handoff, and events related to dynamical evolution of the lists of frequency channel assignments, e.g., channel re-ranking and stability determination. The system-state file 39 stores data indicating presently used channels and time slots for angular sectors S₁-Sₖ, densities of available mobile units M₁-Mₘ, and other data defining the instantaneous state of the simulated system as described below.

The program 30 provides a simulation dynamics that is controlled by event queue 38. The dynamics involves sequentially processing events in the queue 38 and updating the system-state file 39 and queue 38 during the event processing. At any time, a program pointer 40 indicates the event presently being processed, e.g., event K in FIG. 6. In the dynamics, new call creation, channel re-ranking, and stability determination events are either initially added to the event queue 38 or periodically added to the event queue 38. Processing of these three types of events results in the insertion of new events into the event queue 38. Termination of the simulation occurs when the processing of a stability determination event indicates that the evolution of the lists of channel rankings has approached close to a stable fixed point of the evolution. In response to such a determination, the program stores the lists of channel rankings as described in step 26′ of FIG. 5.

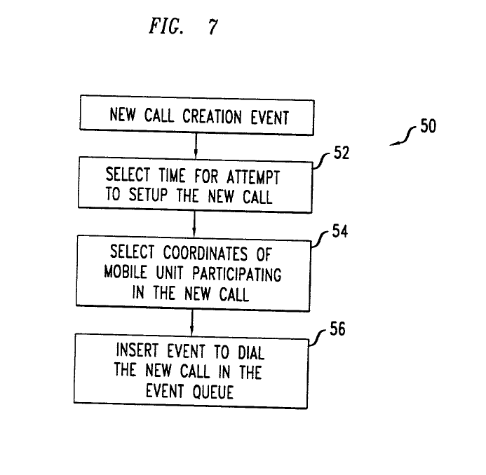

The dynamics that program 30 uses to process events related to calls and events related to channel rankings are described by flow charts shown in FIGS. 7-10 and FIG. 11-12, respectively. The process of the various event types includes inserting, modifying, and/or removing later events from event queue 38 and/or updating the system-state file 39, e.g., changing designations of the used frequency channels and times slots therein for the system's angular sectors.

FIG. 7 is a flow chart 50 showing how program 30 processes a new call creation event. In response to the new call creation event, the program 30 selects a delay time for an attempt to set up the new call, i.e., to dial the new call (step 52). The inter-arrival times “T” between the future times of the dialing event are distributed according to a probability distribution, P(T), e.g., a Poisson distribution. The distribution may be part of the input data or be a default distribution, e.g., P(T)=[a]exp(−aT). In response to the new call creation event, the program 30 also selects a location for the mobile unit M₁-Mₘ that will participate in the new simulated call (step 54). The mobile unit's location is determined from local densities, and call traffic rates of the mobile units M₁-Mₘ. In some embodiments, the determinations of mobile unit locations also depends on availabilities, i.e., mobile units involved in other calls are unavailable. In the simulated dynamics, these properties depend both on the original input data and on the system's state as defined by system-state file 39. For example, the availability of a mobile unit M₁-Mₘ depends on whether the unit has a call, and the local density of mobile units M₁-Mₘ depends on mobile unit motion in embodiments in which the mobile units M₁-Mₘ move.

Some embodiments use stationary densities of mobile units M₁-Mₘ to perform the simulation based on call creation events that fix the call dialing time and mobile unit's location. A new event to dial the call is inserted into event queue 38 at an entry location that corresponds to the call dialing time (step 56). The new event indicates both the location of the mobile unit M₁-Mₘ that will dial or receive the call and the call dialing time, i.e., position in the queue 38.

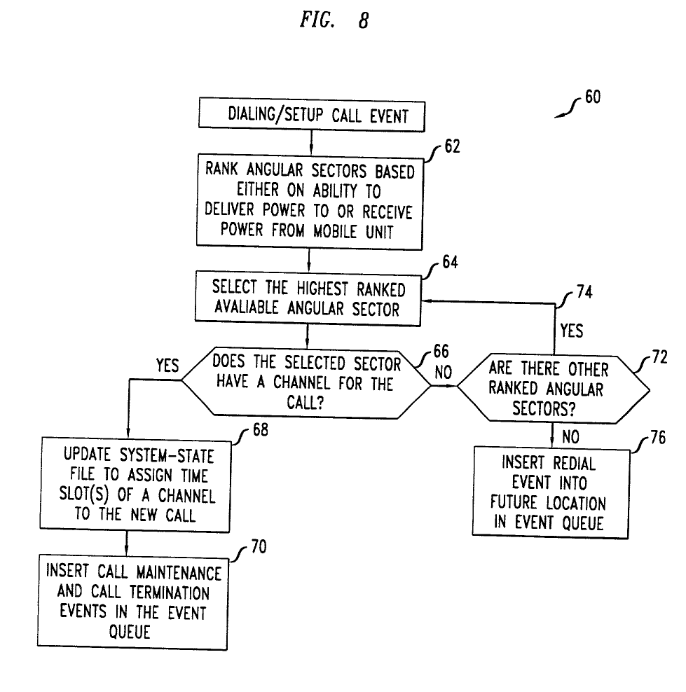

FIG. 8 is a flow chart 60 showing how program 30 of FIG. 5 processes a call dialing event, i.e., an event to set up a scheduled call. In response to such an event, the program 30 ranks angular sectors S₁-Sₖ of base stations B₁-Bₙ located within a predetermined distance of the mobile location (step 62). The angular sectors S₁-Sₖ are ranked based either on a sectors' abilities to deliver signal power to the location of the mobile unit M₁-Mₘ participating in the call or on sectors' sensitivities to signal power from the location of the mobile unit M₁-Mₘ. For an angular sector S₁-Sₖ, the sector's ability to deliver signal power to or sensitivity to signal power from a location is determined from input data that fixes the sector's power or sensitivity and from a fading matrix.

The fading matrix describes signal attenuation between particular base stations B₁-Bₙ (row index) and particular locations (column index) of the mobile units M₁-Mₘ. Often, the fading matrix is based on a power law attenuation of transmitted signal power. An exemplary law provides that transmitted signal power is attenuated like (distance)^{31 3.5}. The entries of the fading matrix also account for shadow attenuation, e.g., as caused by buildings or mountains. In exemplary embodiments, the entries of the fading matrix are derived by program 30 from the input data.

Program 30 selects the highest ranked angular sector S₁-Sₖ that is available to set up the call being dialed (step 64). Then, the program 30 determines whether the selected angular sector S₁-Sₖ has one or more acceptable time slots in a frequency channel to support the dialed call with the participating mobile unit (step 66). For the selected angular sector S₁-Sₖ, the program 30 searches for unused communication time slots in the frequency channel with the highest ranking, i.e., the channel with the lowest interference level. The highest ranked channel is found from the system-state as defined by system state file 39.

A potential time slot is only acceptable if the ratio of the communication power in the slot to the interference power in the same slot (i.e., in the same and adjacent frequency channels) is greater than a predetermined threshold. The communication power depends on the power of the participating mobile unit or angular sector and on the appropriate element in the fading matrix.

In searching for unused time slots, the program 30 considers up to a preselected number of the highest ranked channels in the selected angular sector S₁-Sₖ . If a time slot is found for the call, the program 30 assigns the time slot to the new call by updating the status of the time slot in the system-state file 39 (step 68). In this case, the program 30 finishes setting up the call by creating a future call maintenance event and a future call termination event in event queue 38 (step 70). When processing a call maintenance event, a decision event is made as to whether the call in progress should be continued, dropped, or handed off. Drops and hand-offs are based on call quality considerations. For example, a call drop occurs if the ratio of the signal power to the interference noise power too large at the time of the maintenance event. Similarly, in embodiments implementing handoffs, a handoff occurs when the call quality is improved by transferring the call to another base station B₁-Bₙ. The call termination event causes termination of the call after a selected time, e.g., defined by a probability distribution whose mean time is part of the input data.

If a time slot is not available in the selected angular sector S₁-Sₖ, program 30 determines whether other angular sectors S₁-Sₖ remain in the set of ranked angular sectors (step 72). If other angular sectors remain, the program 30 loops back 74 to repeat the process for the highest ranked one of the remaining angular sectors S₁-Sₖ. If no ranked angular sectors S₁-Sₖ remain, the program 30 creates in event queue 38 an event to redial the call at a future time, because the call is temporarily blocked due to the absence of an appropriate angular sector to support the call (step 76). The redial event simulates a caller's persistence to set up the new call, i.e., by an attempt to redial the call at a future time.

Program 30 processes redial events like new call dialing events except that redial events have associated persistency ratings. The persistency rating tracks the number of tries to redial the blocked call. After a selected number of redial tries, the program 30 does not create further call redialing events. The persistency rating simulates a caller's persistence in retrying to connect a blocked call. In some embodiments, redial persistencies are part of the input data.

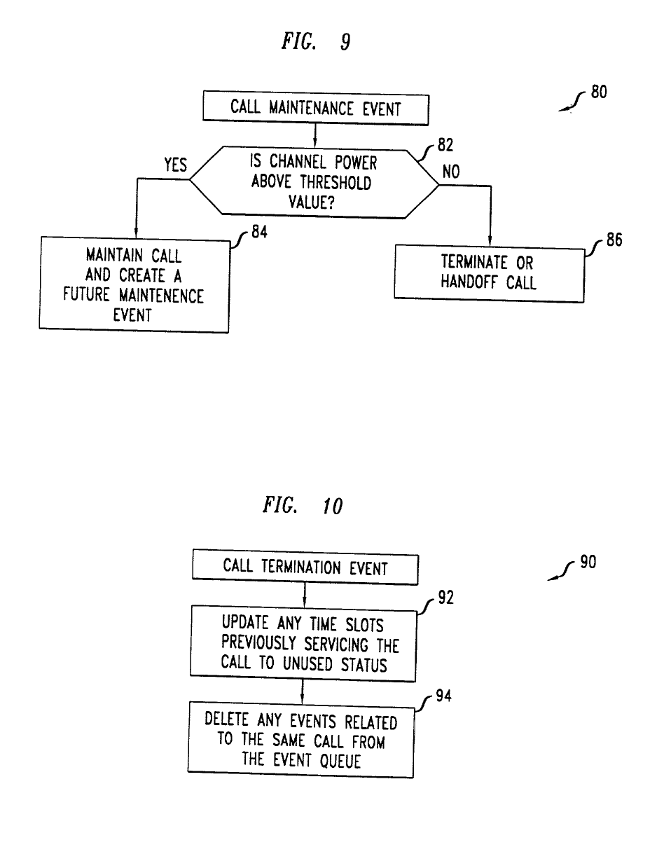

FIG. 9 is a flow chart 80 showing how program 30 processes a call maintenance event. In response to such an event 90, the program 30 determines whether the quality of the communication channel that is supporting the call is above a predetermined threshold value (step 82). The quality is determined from a ratio of the signal power delivered by the servicing angular sector S₁-Sₖ to the participating mobile unit M₁-Mₘ, or the signal power received from the participating mobile unit M₁-Mₘ at the servicing angular sector S₁-Sₖ to the interference power in the channel of the angular sector S₁-Sₖ supporting the call. The power levels are based on input data on properties of the angular sector S₁-Sₖ that is servicing the call, properties of the mobile units M₁-Mₘ, and the fading matrix. The power levels can change, e.g., due to simulated motion of the mobile units M₁-Mₘ. If the ratio of the relevant signal power to the interference (i.e., noise) power level is above a predetermined threshold, the program 30 maintains the call and creates a future call maintenance event for the call (step 84). If the ratio of the relevant signal power level to the interference power level is below the predetermined threshold, the program 30 marks the call as bad and tries to hand off the call to a different angular sector/base station if the simulation supports handoffs (step 86). If the hand off fails after a selected number of the tries the call is dropped. If the embodiment does not support handoff, the call is simply dropped.

Embodiments that support handoffs treat a handoff situation like an event to dial a new call, i.e., to set up the call with a new angular sector S₁-Sₖ. Handoffs are, e.g., supported in embodiments of program 30 that simulate motion of mobile units M₁-Mₘ. If a handoff is not possible, the call is terminated. A termination removes other events related to the same call from event queue 38, e.g., based on a listing of the other events that is stored in system-state file 39, and updates the system-state file 39 to show that time slots that previously supported the call are now unused.

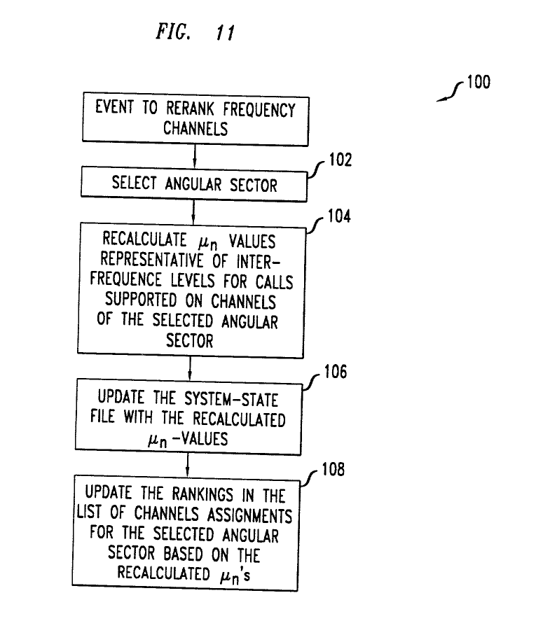

FIG. 10 is a flow chart 90 showing how program 30 processes a call termination event. In response to such an event, the program 30 updates system-state file 39 to free the time slot previously used to support the call (step 92). Freeing the time slot involves updating system-state file 39 to show that the time-slot of the frequency channel in the angular sector S₁-Sₖ that previously supported the call is now unused. The program 30 also removes from event queue 38 any future events that are related to the same call, i.e., based on a list of such events that is stored either in the system-state file 39 or in the event queue 38 itself (step 94). In some embodiments, the program 30 also updates the system-state file 39 to show that the mobile unit M₁-Mₘ previously participating in the call is now available for other calls, i.e., the program 30 updates the density of available mobile units M₁-Mₘ.

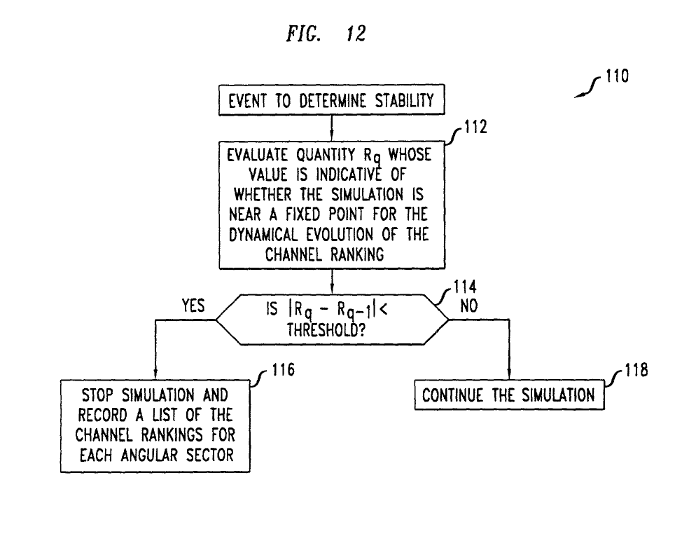

FIG. 11 is a flow chart showing how program 30 processes an event to re-rank one or more frequency channels of an angular sector S₁-Sₖ. The program 30 selects an angular sector S₁-Sₖ whose ranking is to be updated (step 102). In exemplary embodiments, this selection of angular sectors S₁-Sₖ is either performed randomly or in round robin fashion. For the selected angular sector S₁-Sₖ, the program 30 recalculates a quantity, μₙ, representative of interference that a call supported by one or more selected frequency channels of that selected angular sector S₁-Sₖ would experience (step 104). The program 30 updates the system-state file 39 with the recalculated μₙ values (step 106).

The calculation of μₙ at time “n” is based on a measured interference level, i.e., mₙ in decibels, and on the previous value of μₙ₋₁ for the same frequency channel of the angular sector under consideration. The measured interference level, mₙ, depends on which other channels in the selected angular sector and on which channels in other angular sectors are presently supporting communications. Typically, interference measurements are restricted to nearby base stations B₁-Bₙ and to simulated communications in the same and adjacent frequency ranges, because other communications produce little interference for the selected angular sector and channel thereof. Interference levels are averages over various time slots of the selected channel in simulations that simulate time division multiplexing. The contribution to μₙ from the previous interference value, i.e., μₙ₋₁, smoothes out rapid fluctuations in channel activity levels. In exemplary embodiments, μₙ=(1−a)μₙ₋₁+αmₙ with 0<α<1 and preferably α<0.1.

From the updated list of values of μₙ, the program 30 updates the rankings of frequency channels for the selected angular sector S₁-Sₖ (step 108). This updating includes updating the list of channel rankings that is associated with the selected angular sector S₁-Sₖ. The lists of channel rankings for the various angular sectors S₁-Sₖ are located in the system-state file 39, e.g., list 3 of FIG. 2. The updated list of channel rankings affects the future processing of call dialing events.

In various embodiments, program 30 re-ranks different portions of the list of frequency channels in response to an event to re-rank the channels for a particular angular sector. In some embodiments, the list of channel rankings for each angular sector includes a pointer so that updating of the μₙ values is performed in round-robin fashion for individual sectors. Then, processing of several events to re-rank the channels of the same angular sector results in an update of the entire list of channel rankings of the sector.

In some embodiments, each list of frequency channels, e.g., list 3 of FIG. 2, includes a short list of the highest ranked channels for the associated angular sector S₁-Sₖ. The short list includes the subset of the channels that the associated angular sector S₁-Sₖ uses to support communications with mobile units M₁-Mₘ. Typically, events to re-rank frequency channels more frequently re-rank the channels on the short list, channels and less frequently re-rank the remaining channels. In one embodiment, the μₙ's that are indicative of interference levels evolve differently for channels on the short list and for the remaining channels. In particular, the equations, i.e., μₙ=(1−α)μₙ₋₁+αμₙ, use an α=α_{S} as in the equations for channels on the short list and use an α=α_{L} in the equations for the remaining channels. Furthermore, α_{S}>>α_{L}, which implies that the channels on the short list have their μₙ variables updated more rapidly.

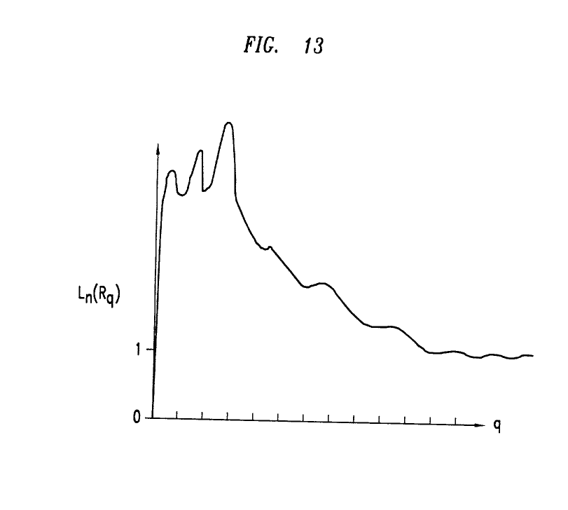

FIG. 12 is a flow chart 110 showing how program 30 processes a stability determination event, which is indexed by a temporal sequence number “q”. In response to such an event, the program 30 evaluates a quantity, R_{q} whose value is indicative of whether the simulation of the system's channel rankings is converging to a fixed point (step 112). An exemplary formula for R_{q} is:

R_{q}=Σ_{angular sectors Sp}(rank change of last updated channel)/k.

The rank changes are integers that describe how far the last updated frequency channel's rank was changed during the last re-ranking event for the associated angular sector S₁-Sₖ. The processing of a channel re-ranking event includes storing this integer in a subfile located in the system-state file 39. The subfile has k entries, i.e., one entry for each angular sector S₁-Sₖ.

FIG. 13 shows the general behavior of the quantity R_{q} with the event index number “q”. Initially, R_{q} is large and may increase or strongly fluctuate with increasing sequence number “q”. But, as a fixed point is approached, fluctuations in the value of R_{q} start to decrease, because the re-ranking process of FIG. 11 leads to less reorderings of the frequency channels for the various angular sectors S₁-Sₖ. As the simulation time increases, the values of R_{q} for sequential “stability determination events”, i.e., sequential “q”, go to a constant value, e.g., zero. The values of the R_{q}'s also become smaller as “q” grows, because fewer re-ranking of frequency channels occur. Of course, other formula for quantity R_{q} could also provide measures of the distance of the system evolution from a fixed point.

Referring again to FIG. 12, program 30 compares the value of quantity R_{q} for the latest stability determination event “q” with the value of R_{q-p} for an earlier stability determination event “q-p” where “p” is a preselected number (step 114). The comparison determines whether |R_{q}-R_{q-p}| is converging to zero. In some embodiments, the program 30 finds convergence if |R_{q}-R_{q-p}| has monotonic decreasing oscillations as a function of “q”, e.g., oscillations whose magnitude decrease faster than a preselected function of “q”. In other embodiments, the program 30 finds convergence if |R_{q}-R_{q-p}| is smaller than a predetermined threshold. In response to finding such convergence, the program 30 stops the simulation and records a list of the channel rankings for each angular sector S₁-Sₖ (step 116). In such a case, the dynamical simulation is near a fixed point for dynamical evolution of the “k” lists of channel rankings. Then, the recorded lists of channel rankings provide data that base stations B₁-Bₙ of the actual cellular system 2 will use to assign frequency channels during later processing of real communications with mobile units M₁-Mₘ. If the program 30 does not find that |R_{q}-R_{q-p}| is converging, the program 30 continues the simulation of cellular system 2 (step 118).

Other embodiments of simulation program 30 handle events related to call processing and events related to the evolution of the lists of channel rankings separately. For example, one embodiment includes separate event queues for these two types of events (not shown). In that embodiment, the program performs time sharing operations in which a predetermined percentage of the simulation time is used to process events from each queue.

Other embodiments of simulation programs rank frequency channels on a per base station basis rather than on a per angular sector basis.

Other embodiments of the invention will be apparent to those skilled in the art in light of the specification, drawings, and claims of this application.

What is claimed is:

1. A process for assigning frequency channels to communications in a cellular wireless system, comprising:
performing a simulation of the system to produce a plurality of lists of channel rankings, the simulation evolving the lists according to an algorithm that dynamically reduces inter-communication interference, ones of the lists of channel rankings prioritizing the channels to service communications by associated ones of the base stations; and
assigning the lists of produced channel rankings to associated base stations that are configured to assign channels to service communications with mobile units based on the channel ranking in the associated assigned ones of the lists.

2. The process of claim 1, wherein the evolving is constrained to produce less than a preselected amount of call blocking and/or call dropping.

3. The process of claim 1, wherein one of the produced lists of channel rankings separately ranks the channels for separate angular sectors of the associated base station.

4. The process of claim 3, wherein the performing includes producing a list that serially ranks the channels for usage in servicing wireless communications.

5. The process of claim 4, wherein the performing comprises:
identifying the produced lists of channel rankings in response to determining that the performing is converging to a fixed point for evolution of the lists of channel rankings.

6. The process of claim 5, wherein the performing comprises:
determining quantities that characterize communications serviced by one of the angular sectors, individual ones of the quantities being indicative of potential inter-call interference for calls serviced by associated ones of the frequency channels; and
re-ranking the list of frequency channels associated with the one of the angular sectors based on the determined quantities.

7. The process of claim 5, wherein the performing comprises:
providing a fading matrix for the system; and
wherein the performing includes assigning new calls to base stations based in part on the fading matrix.

8. The process of claim 5, further comprising:
providing input data on locations of base stations and distributions of mobile units; and
wherein the performing is based in part on the provided input data.

9. The process of claim 5, wherein the performing includes simulating redialing of blocked calls.

10. The process of claim 5, wherein the performing includes simulating maintenance processing of calls based on associated power levels.

11. The process of claim 5, wherein the performing includes assigning new calls according to a time division-multiplexing scheme.

12. The process of claim 5, further comprising:
servicing new calls in the base stations based on priorities derived from the assigned lists of channel rankings.

13. The process of claim 5, wherein the algorithm lowers interference based solely on uplink communications.

14. The process of claim 5, wherein the algorithm lowers interference based solely on downlink communications.

15. A program storage device encoding a computer executable program of instructions to rank frequency channels of a cellular wireless system, the instructions to cause the computer to:
perform a simulation of the system to produce a plurality of lists of channel rankings, the simulation evolving the lists according to an algorithm that dynamically reduces inter-communication interference, ones of the lists of channel rankings prioritize the channels to service communications by associated ones of the base stations; and
assign the lists of produced channel rankings to the base stations for use in assigning channels to service communications with mobile units.

16. The device of claim 15, wherein the simulation evolves the lists without producing more than a preselected amount of call blocking and/or call dropping.

17. The device of claim 15, wherein one of the produced lists of channel rankings separately ranks the channels for separate angular sectors of the associated base station.

18. The device of claim 17, wherein the instruction to perform produces a list that serially rankings of the channels for usage in servicing wireless communications.

19. The device of claim 18, wherein the instruction to perform causes the computer to identify the produced lists of channel rankings in response to determining that the performing a simulation is converging to a fixed point for evolution of the lists of channel rankings.

20. The device of claim 19, wherein the instruction to perform further causes the computer to:
determine quantities that characterize communications serviced by one of the angular sectors, individual ones of the quantities being indicative of potential inter-call interference for calls serviced by associated ones of the frequency channels; and
re-rank the list of frequency channels associated with the one of the angular sectors based on the determined quantities.

21. The device of claim 19, wherein the instruction to perform causes simulated redialing of blocked calls.

22. The device of claim 19, wherein the instruction to perform causes simulated maintenance processing of calls based on associated power levels.

23. The device of claim 19, wherein the instruction to perform causes processing of simulated calls according to a time division-multiplexing scheme.

24. A channel allocation system for ranking frequency channels for usage by base stations of a cellular wireless system, comprising:
a processor configured to dynamically simulate the cellular wireless system according to an algorithm that dynamically produces lists of frequency channel rankings for individual base stations in a manner that reduces inter-call interference.

25. The allocation system of claim 24, further comprising:
a link coupling the processor to the base stations, the link supporting transmissions of input data on the cellular wireless system to the processor and transmissions of the produced lists of channel rankings to the base stations, the processor configured to use the input data to determine a starting state for the dynamical simulation.

26. The allocation system of claim 24, wherein the processor is configured to produce separate lists that rank the frequency channels for use in separate angular sectors of at least one of the base stations in assigning channels to support communications.

27. The allocation system of claim 26, further comprising:
a plurality of base stations, each base station having a data storage device configured to store ones of the produced lists received from the processor.

28. The allocation system of claim 26, wherein the processor is configured to perform the dynamical simulation based on an event queue containing events for simulating processing of communications with mobile units.

29. A process for assigning frequency channels to communications in a cellular wireless system, comprising:
performing an iterative algorithm to produce a plurality of lists of channel rankings, the algorithm evolving the lists according to reduce inter-communication interference, ones of the lists of channel rankings prioritizing the channels to service communications by associated ones of the base stations; and
assigning the lists of produced channel rankings to associated ones of the base stations, the base stations being configured to assign channels to service communications with mobile units based on the rankings in the associated ones of the lists.

30. The process of claim 29, wherein the algorithm is constrained to produce less than a preselected amount of communication blocking and/or dropping.

31. The process of claim 29, wherein one of the produced lists of channel rankings separately ranks the channels for separate angular sectors of the associated base station.

32. The process of claim 31, wherein the performing includes producing a list that serially ranks the channels for usage in servicing wireless communications.

33. The process of claim 31, wherein the performing comprises:
identifying the produced lists of channel rankings in response to determining that the performing is converging to a fixed point for evolution of the lists of channel rankings.
